(19) United States
(12) Patent Application Publication
(10) Pub. No.: US 2016/0238196 A1
(43) Pub. Date: Aug. 18, 2016

(54) VARIABLE INTENSITY STREET LAMP LED RETROFIT KIT

(71) Applicant: Oscar Fondeur, Kissimmee, FL (US)

(72) Inventor: Oscar Fondeur, Kissimmee, FL (US)

(21) Appl. No.: 14/623,277

(22) Filed: Feb. 16, 2015

(51) Int. Cl. F21K 99/00; F21V 23/02; F21V 23/00; F21S 8/08; F21V 23/04

(52) U.S. Cl. CPC F21K 9/13; F21S 8/085; F21V 23/0471; F21V 23/007; F21V 23/023; F21Y 2101/02

(57) ABSTRACT

A variable intensity street lamp led retrofit kit includes an LED light unit having multiple LED lights and a screw-type power base. A control unit having a shape and size that is complementary to a ballast box includes an AC to DC power source, a timer module, and a dimmer unit. The power source provides power for the operation of the LED light unit, the dimmer adjusts the output power to control an intensity of the LED light unit, and the timer adjusts a duration of the light operation. A motion sensor detects movement and interrupts the dimmer operation.

### TECHNICAL FIELD

The present invention relates generally to the field of lighting, and more particularly to a retrofit kit for converting a non-LED street lamp into an energy saving LED lamp with motion sensor and variable intensity settings.

### BACKGROUND

The statements in this section merely provide background information related to the present disclosure and may not constitute prior art.

Many businesses who have outdoor areas such as parking lots, for example, utilize a large amount of electricity to power their outdoor lighting systems during off-peak hours or when the business itself is closed. In this regard, many public safety laws require that a business keep their parking lot street lights illuminated throughout the night. Depending on the number of street lights and/or the type of lighting involved, this expenditure can cost a business thousands of dollars a year.

For many years, street lights have utilized low efficiency lamps. At one time, incandescent lamps were used for such lighting fixtures, but over the years, incandescent lamps have often been replaced with fluorescent, high-intensity discharge (HID), and mercury-vapor lamps. Recently, light emitting diode (LED) lamps have become available for such applications. LED lamps offer several advantages, including improved light quality, performance, life span, and costs, and their use and popularity have increased as high lumen LEDs have been developed. LED lighting offers the potential for significant reductions in power consumption per lumen.

One factor limiting the use of LED lighting systems has been the cost and inconvenience of removing conventional non-LED-based light fixtures or luminaires and installing new light fixtures that are designed and optimized for LED lamps. To defray this expense, attempts have been made to incorporate LED lamps in and on the surface of conventional non-LED light housings. One such approach includes U.S. Patent Application No. 2012/0051048, to Smit, the contents of which are incorporated herein by reference.

This approach, while useful in some applications, does not provide a palatable solution to business owners, who wish to drastically cut their energy bills related to their outdoor street lights. Accordingly, it would be beneficial to provide a kit which can retrofit an existing street light into an energy saving LED light with a motion sensor and variable intensity settings.

### SUMMARY OF THE INVENTION

The present invention is directed to a retrofit kit for street lamps. One embodiment of the present invention can include an LED light unit having multiple LED lights and a screw-type power base. The light unit can plug into an existing lamp socket, and a control unit can replace an existing ballast box. The control unit can include an AC to DC power source, a timer module, and a dimmer unit. The power source can provide power for the operation of the LED light unit, the dimmer can adjust the output power to control an intensity of the LED light unit, and the timer can adjust a duration of the light operation.

In another embodiment, operation of the dimmer unit can be affected by a motion sensor which can detect movement.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a side cutout view of a street lamp in accordance with the background art.

FIG. 2 is an exploded parts view of the variable intensity street lamp LED retrofit kit, in accordance with one embodiment of the invention.

FIG. 3 is simplified block diagram of the control unit of the variable intensity street lamp LED retrofit kit, in accordance with one embodiment of the invention.

FIG. 4 is a perspective view of the variable intensity street lamp LED retrofit kit in operation, in accordance with one embodiment of the invention.

FIG. 5 is a perspective view of the variable intensity street lamp LED retrofit kit in operation, in accordance with another embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

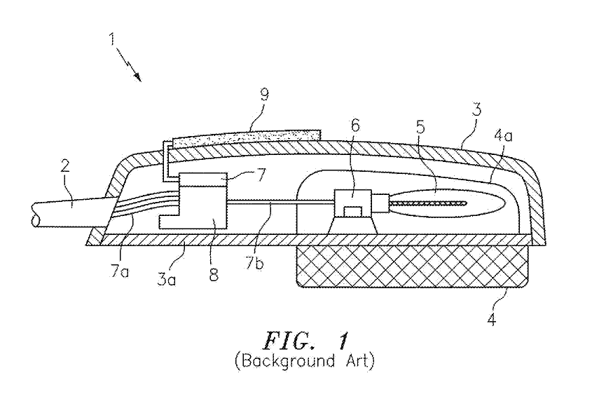

Identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

FIG. 1 illustrates one embodiment of a conventional street lamp that is useful for understanding the inventive concepts described below. As shown, the lamp 1 includes a support bridge arm 2 adapted to be secured to a pole whereby to support the head elevated above a ground surface. Typically these heads are supported a distance of 20 to 30 feet above the ground, depending on their use. The unit 1 includes a protective enclosure 3 which functions to protect the lamp components from the elements. These enclosures include a variety of different shapes and sizes depending on the type of bulb to be utilized, and the intended use/location of the lamp. In either instance, the enclosure is typically constructed from a cast of aluminum and includes a hinged lower section 3a having a glass diffuser 4 secured thereon. The hinge section functioning to provide access to the lamp components.

An internally located light reflector 4a is secured within the main body and functions to direct light from the light bulb 5 out, through the glass diffuser. The light bulb is secured within a screw socket 6 that is connected to a power supply transformer 7. A/C power is received through input lines 7a, and delivered to the socket via output lines 7b. A ballast box 8, light sensor 9 and various switches and connectors as are conventional with street lamps are also included.

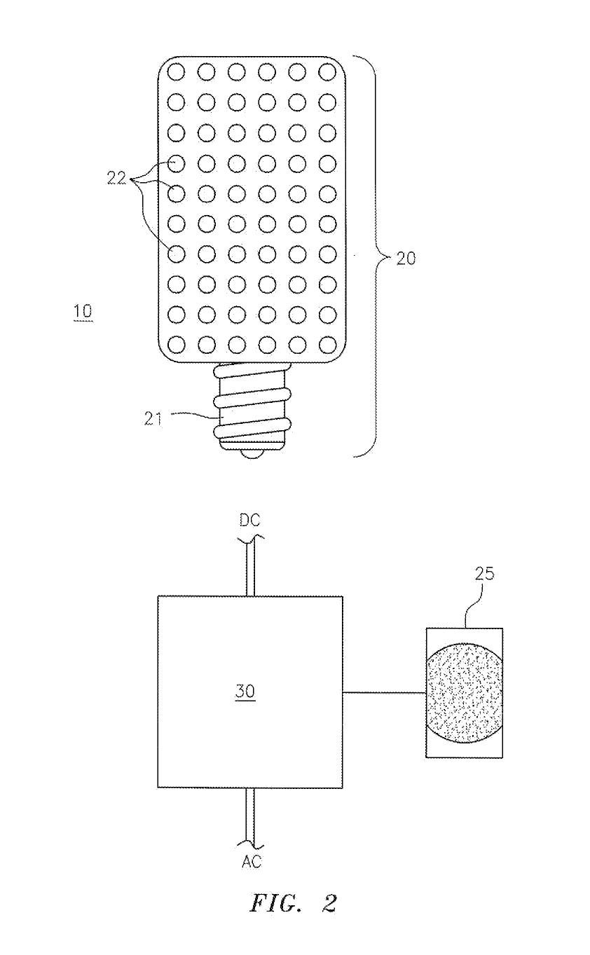

FIGS. 2-4 illustrate various embodiments of a variable intensity LED retrofit kit 10, in accordance with the inventive concepts disclosed herein. As shown in FIG. 2, one embodiment of the kit 10 can include a screw base LED light unit 20, an externally mountable motion sensor 25, and a control unit 30.

As shown, the light unit 20 can include a standard sized (e.g., E27 or E40) screw base 21 for engaging the existing screw socket 6 of an existing street lamp 1. A plurality of LED lighting elements 22 can be arranged along the light body and function to generate a required light output. The exact number of LED's, the light output, and the power requirements of the same can vary depending on the lamp into which the kit will be retrofitting. However, one example of a suitable light unit includes the G90-C40C LED Street Lamp canopy bulb that is commercially available from CREE, Inc.

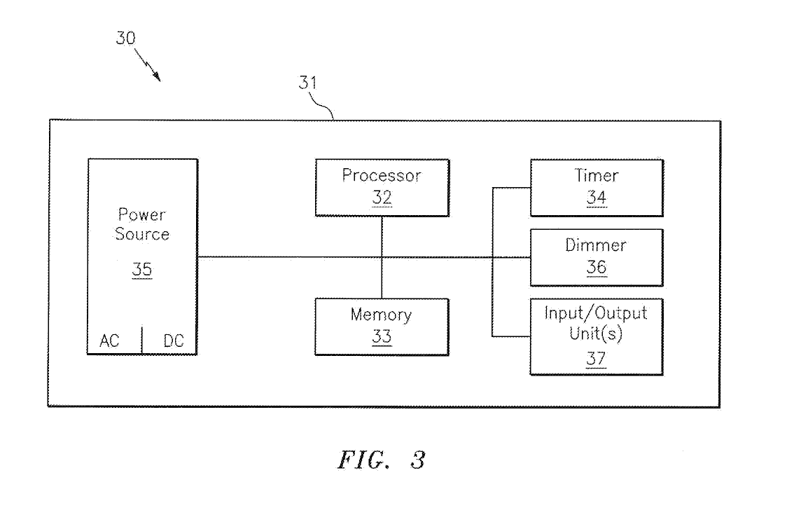

FIG. 3 illustrates one embodiment of a control unit 30 which can control an operation of the light unit. As shown, the control unit 30 can include an outer shell/body 31 having a processor 32 that is conventionally connected to an internal memory 33, a timer module 34, a power supply 35, a dimmer unit 36, and one or more input/output units 37.

Although illustrated as separate elements, those of skill in the art will recognize that one or more system components may be, or include one or more printed circuit boards (PCB) containing an integrated circuit or circuits for completing the activities described herein. The CPU may be one or more integrated circuits having firmware for causing the circuitry to complete the activities described herein. Of course, the controller is not to be construed as limiting to the above noted components, as any number of different components which can be arranged so as to perform the below described controller functionality are also contemplated.

The main body 31 can house each of the controller elements in a conventional manner, so as to create a single device. In this regard, the main body 31 can take any number of different shapes and sizes, and can be constructed from any number of different materials and methods. In one preferred embodiment, the main body 31 can include a shape and size that is complementary (e.g., nearly identical) to the shape and size of the traditional non-LED street lamp ballast box 8 for which the kit 10 is intended to be placed. In this regard, the controller body 31 can also be constructed from lightweight injection molded plastic having a plurality of internal connectors (not shown) for securely housing each of the device elements. Of course, any number of known shapes, sizes and construction materials such as PVC, metal and/or composites, for example, are also contemplated.

The processor/CPU 32 can act to execute program code stored in the memory 33 in order to allow the device to perform the functionality described herein. Likewise, a timer module 34 can be provided, and can function to accurately measure the passage of time. As described herein, the timer module can be provided as a function of the processor or can include a separate physical circuit. In either instance, processors and timers are extremely well known in the art, therefore no further description will be provided.

Memory 33 can act to store operating instructions in the form of program code for the processor 32 to execute. In this regard, the memory 33 can include any type of memory elements such as random access memory or other non-persistent memory device(s), for example, that are generally used during the execution of program code. Memory devices are extremely well known in the art.

The power supply 35 can function to convert the AC power supplied to the lamp into DC for powering the light unit 20. Although preferably located within the control unit 20, other embodiments are also contemplated wherein the AC power (which can be modulated by the dimmer) is supplied directly to the light unit 20, and the light unit itself has an integrated AC to DC converter onboard.

The dimmer unit 36 can function to adjust the output of the power supply so as to affect the intensity of the light unit 20. In one embodiment, the dimmer unit can be pre-programmed to produce power output in three distinct modes: full power (e.g., 100%), half power (e.g., 50-75%) or OFF. Of course, any number of other power output modes are also contemplated. Moreover, the dimmer unit can be adjustable by a user so as to allow the user to specify an exact power output.

One or more input/output units 37 can be provided so as to allow the control unit to communicate with any number of external components, such as the lamps daylight sensor 9, and/or the motion sensor 25. In this regard, the input/output unit can include any number of components such as a USB cable connector, or other such device capable of sending and receiving information to the external components.

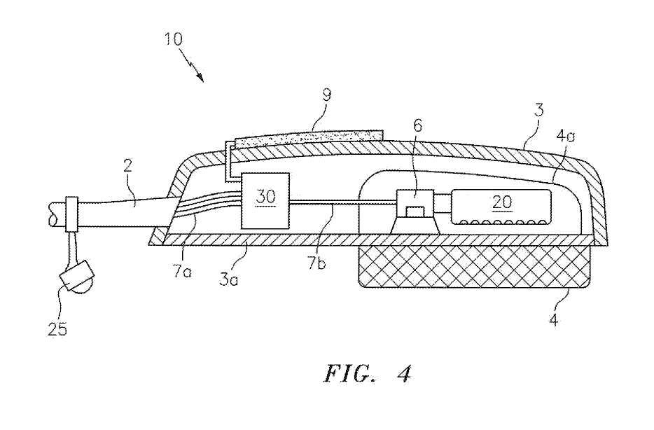

FIG. 4 illustrates one embodiment of the kit 10 installed into an existing street lamp. As shown, the control unit 30 can replace the existing ballast box 8 and can be connected to the input and output power lines 7a and 7b, respectively. Likewise, the LED light unit 20 can be screwed into the existing socket 6 which is also connected to the output lines 7b. AC power can be converted into useable DC power via the power source 35. This DC power can be utilized to operate one or both of the control unit itself and the light unit 20. Finally, the motion sensor 25 which is connected to one of the input/output units can be secured onto the pole or support arm 2 via a clip or other such fastener 25a, and the existing light sensor 9 can be plugged into another input/output unit 37.

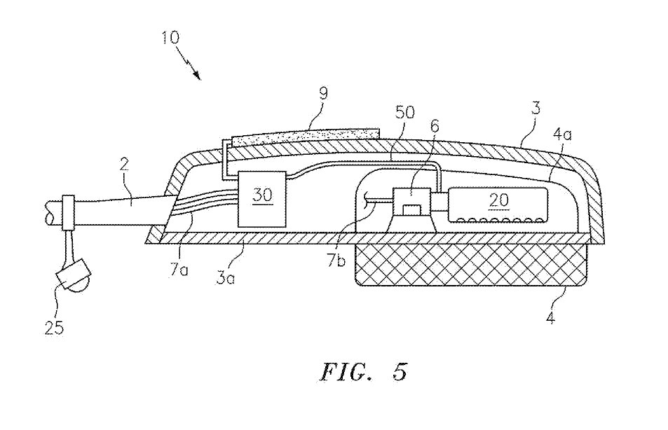

FIG. 5 illustrates another embodiment of the kit 10, that further includes a power supply line 50 which can provide power directly to the LED light unit 20 from the power source of the controller 30. Such a feature may be beneficial in situations where the output lines 7b of an existing lamp are damaged or not otherwise desirable for use. As shown, the LED unit 20 can still be secured within the existing socket 6, so as to be oriented in a manner that can direct light through the diffuser 4. As described herein, the supply line 50 can be either permanently or removably secured to each of the LED light unit and the controller, in accordance with known manufacturing techniques.

Although not illustrated, any number of additional components typically incorporated into the use and deployment of LED lighting can also be included. Several such examples include various forms of heat dissipation units (i.e., heat syncs) temperature sensors and the like.

In operation, the memory 33 can be encoded with instructions for instructing the processor to perform an energy saving light operation as described below. As such, upon determining that the natural light level is below a desired threshold (i.e., that it is dusk, for example) via the light sensor 9, the processor can instruct the timer to begin a first countdown. Alternatively, the first countdown can be initiated by the timer and can be set by a user, so as to automatically begin at a specified time each day.

In one embodiment, the first countdown can include an amount of time until which the business is at off-peak hours or is closed. For example, if a business closes at 10 pm, and it gets dark at 7 pm, the first countdown can be 3 hours. During the first countdown, the dimmer unit 36 can be set to operate at full power mode, wherein full power is supplied to the LED light unit 20 so as to provide maximum illumination to the area.

Upon reaching the end of the first countdown, the processor 32 can simultaneously activate the motion sensor 25, and can instruct the dimmer unit to operate at half power mode, wherein reduced power is supplied to the LED light unit, resulting in a lower light level and less energy expenditure. In this regard, if movement is detected by the motion sensor, the processor can immediately instruct the dimmer unit to provide full power to the LED light for a second period of time, such as 5 minutes, for example. The unit can remain in this mode until either the light sensor 9 determines that there is sufficient daylight so as to deactivate the LED light, or until instructed to shut off by a user.

Accordingly, by replacing highly inefficient light bulbs which operate at full capacity all of the time, with an energy saving LED light unit having a power modulated controller that adjusts the light output to an as-needed basis, the presently claimed invention can provide substantial savings to a user. Moreover, by providing a retrofit kit which can be incorporated into any existing street lamp unit, the inventive concepts disclosed herein can reduce the cost and waste associated with replacing existing street lamp structures in their entirety.

As described herein, one or more elements of the variable intensity street lamp led retrofit kit 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one continuous element, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A retrofit kit for a street lamp having a lamp socket, a light sensor, and a ballast box, said kit comprising:
a light unit that includes a plurality of LED elements;
a motion sensor that is configured to detect movement; and
a control unit having a shape and size that is complementary to a shape and size of the ballast box, said control unit being in communication with each of the light sensor, the motion sensor, and the light unit.

2. The kit of claim 1, wherein the control unit further includes:
one or more input output units that function to communicate with the light sensor;
an AC to DC power source having a connector for communicating with the lamp socket and for supplying a DC power output thereto.

3. The kit of claim 2, wherein the light unit includes a screw base that functions to engage the lamp socket to receive the DC power output from the power source.

4. The kit of claim 3, wherein the control unit further comprises:
a dimmer unit;
a timer module;
a memory; and
a processor that is in communication with, and controls an operation of each of the power source, the dimmer unit, the memory and the timer module.

5. The kit of claim 4, wherein the dimmer unit is in communication with the power source, and functions to operate in a plurality of different modes, said modes including:
a first mode wherein 100% of the DC power output is sent from the power source to the lamp socket,
a second mode wherein approximately 50% of the DC power output is sent from the power source to the lamp socket, and
a third mode wherein no DC power is sent from the power source to the lamp socket.

6. The kit of claim 5, wherein the controller includes functionality so that upon receiving a signal from the light sensor, the processor functions to activate the timer for a first countdown period, and to operate the dimmer unit in the first mode for a duration of the first countdown period.

7. The kit of claim 6, wherein the memory includes programming for instructing the processor to operate the dimmer unit in the second mode upon receiving an indication from the timer that the first countdown period has expired.

8. The kit of claim 7, wherein the memory includes programming for instructing the processor to activate the motion sensor when the dimmer unit is in the second mode.

9. The kit of claim 8, wherein the controller includes functionality so that upon receiving a movement signal from the motion sensor, the processor functions to activate the dimmer in the first operating mode, and further instructs the timer to begin a second countdown period.

10. The kit of claim 9, wherein the memory includes programming for instructing the processor to operate the dimmer unit in the second mode upon receiving an indication from the timer that the second countdown period has expired.

11. A retrofit kit for a street lamp having a lamp socket, a light sensor, and a ballast box, said kit comprising:
a light unit that includes a plurality of LED elements and a screw base that functions to removably engage the lamp socket;
a motion sensor that is configured to detect movement; and
a control unit having a shape and size that is complementary to a shape and size of the ballast box, said control unit including
one or more input output units that function to communicate with each of the motion sensor and the light sensor,
an AC to DC power source having a connector for communicating with the light unit and for supplying a DC power output thereto,
a dimmer unit,
a timer module,
a memory, and
a processor that is in communication with, and controls an operation of each of the power source, the dimmer unit, the memory and the timer module.

12. The kit of claim 11, wherein the dimmer unit is in communication with the power source, and functions to operate in a plurality of different modes, said modes including:
a first mode wherein 100% of the DC power output is sent from the power source to the light unit,
a second mode wherein approximately 50% of the DC power output is sent from the power source to the light unit, and
a third mode wherein no DC power is sent from the power source to the light unit.
